(19) United States
(12) Patent Application Publication
(10) Pub. No.: US 2024/0068798 A1
(43) Pub. Date: Feb. 29, 2024

(54) MEASURING DEVICE AND MACHINING DEVICE

(71) Applicant: Tokyo Seimitsu Co., Ltd., Tokyo (JP)

(72) Inventor: Tasuku SHIMIZU, Tokyo (JP)

(73) Assignee: Tokyo Seimitsu Co., Ltd., Tokyo (JP)

(21) Appl. No.: 18/237,527

(22) Filed: Aug. 24, 2023

(30) Foreign Application Priority Data
Aug. 29, 2022 (JP) 2022-135897

(51) Int. Cl. G01B 11/00; G01B 5/008; G01B 11/24

(52) U.S. Cl. CPC G01B 11/005; G01B 5/008; G01B 11/2441

(57) ABSTRACT

A measuring device includes a table on which a workpiece is to be mounted, a first imaging unit configured to image the surface of the workpiece on the table, a second imaging unit configured to image the surface of the workpiece on the table, the second imaging unit allowing measurement of a shape and/or roughness of the surface of the workpiece according to a plurality of images taken by scanning the surface of the workpiece in a Z-axis direction, and an image processing unit configured to process the image of the surface of the workpiece taken by the first imaging unit and the plurality of images taken by scanning the surface of the workpiece in the Z-axis direction by the second imaging unit, so as to measure the shape and/or the roughness of the surface of the workpiece.

### CROSS-REFERENCE TO RELATED APPLICATIONS

This application claims the priority benefit under 35 U.S.C. § 119 of Japanese Patent Application No. 2022-135897 filed on Aug. 29, 2022, which is hereby incorporated in its entirety by reference.

### BACKGROUND OF THE INVENTION

### Field of the Invention

The presently disclosed subject matter relates to a measuring device and a machining device, and more particularly relates to a measuring device which performs non-contact measurement of a shape and/or roughness of a surface of a workpiece, and a machining device including the measuring device.

### Description of the Related Art

White light interferometers are known as devices which perform non-contact measurement of a fine three-dimensional shape or roughness of a surface of a workpiece (for example, Japanese Patent Application Laid-Open No. 2011-508241, etc.).

### CITATION LIST

Patent Literature 1: Japanese Patent Application Laid-Open No. 2011-508241

### SUMMARY OF THE INVENTION

However, in measurements with white light interferometers, noise may be generated in a vicinity of the surface, and this noise causes instability and false detection in a case of extracting an original shape.

The presently disclosed subject matter has been made in view of such circumstances, and an object of the presently disclosed subject matter is to provide a measuring device and a machining device capable of measuring the shape and/or roughness of the surface of a workpiece with high accuracy.

In order to accomplish the above object, a measuring device of a first aspect includes a table having a mounting surface on which a workpiece is to be mounted, the mounting surface being parallel to a plane including an X-axis and a Y-axis, with respect to the X-axis, the Y-axis, and a Z-axis which are orthogonal to each other, a first imaging unit configured to image a surface of the workpiece on the table, a second imaging unit configured to image the surface of the workpiece on the table, the second imaging unit allowing measurement of a shape and/or roughness of the surface of the workpiece according to a plurality of images taken by scanning the surface of the workpiece in a Z-axis direction, a driving part configured to move the first imaging unit and the second imaging unit relative to the table along directions of the X-axis, the Y-axis and the Z-axis, an imaging control unit configured to control the first imaging unit, the second imaging unit, and the driving part so as to control imaging of the workpiece by the first imaging unit and the second imaging unit, and an image processing unit configured to process the image of the surface of the workpiece taken by the first imaging unit and the plurality of images taken by scanning the surface of the workpiece in the Z-axis direction by the second imaging unit, so as to measure the shape and/or the roughness of the surface of the workpiece.

The measuring device of a second aspect is configured such that, in the measuring device of the first aspect, the image processing unit includes a first image processing unit configured to process a plurality of images, taken by scanning the surface of the workpiece in the Z-axis direction by the first imaging unit, so as to detect a position and/or an edge of the surface of the workpiece in the Z-axis direction, a second image processing unit configured to process the plurality of images, taken by scanning the surface of the workpiece in the Z-axis direction by the second imaging unit, so as to measure the position and/or the roughness of the surface of the workpiece, and an integration processing unit configured to integrate processing results of the first image processing unit and the second image processing unit to calculate a final shape and/or roughness.

The measuring device of a third aspect is configured such that, in the measuring device of the second aspect, the integration processing unit specifies the position and/or the edge of the surface of the workpiece in the Z-axis direction, based on at least a detection result of the position and/or the edge of the surface of the workpiece in the Z-axis direction by the first image processing unit.

The measuring device of a fourth aspect is configured such that, in the measuring device of the second aspect, the imaging control unit sets a scanning range in the Z-axis direction by the second imaging unit, based on information on the position of the surface of the workpiece in the Z-axis direction which is detected by the first image processing unit.

The measuring device of a fifth aspect is configured such that, in the measuring device of the first aspect, the first imaging unit images the surface of the workpiece with a wider visual field than the second imaging unit, and the image processing unit detects a measurement position based on the image taken by the first imaging unit.

The measuring device of a sixth aspect is configured such that, in the measuring device of the first aspect, the first imaging unit has a function to switch an imaging magnification.

The measuring device of a seventh aspect is configured such that, in the measuring device of the second aspect, the first image processing unit processes a plurality of images different in focal position, taken by scanning the surface of the workpiece in the Z-axis direction with the first imaging unit, so as to measure the shape and/or the roughness of the surface of the workpiece.

The measuring device of an eighth aspect is configured such that, in the measuring device of the seventh aspect, the integration processing unit specifies the position and/or the edge of the surface of the workpiece in the Z-axis direction, based on at least a processing result by the first image processing unit.

The measuring device of a ninth aspect is configured such that, in the measuring device of the eighth aspect, when the surface of the workpiece includes an area constituted of a smooth surface, the integration processing unit calculates a shape and/or roughness of the area constituted of the smooth surface, based on a processing result by the second image processing unit, and calculates a shape and/or roughness of areas other than the area constituted of the smooth surface, based on the processing result by the first image processing unit.

The measuring device of a tenth aspect is configured such that, in the measuring device of any one of the first to ninth aspects, the second imaging unit images the surface of the workpiece using an optical interference system or a confocal system.

The measuring device of an eleventh aspect is configured such that, in the measuring device of any one of the first to ninth aspects, the driving part independently moves the second imaging unit and the first imaging unit with respect to the table at least in the Z-axis direction.

The measuring device of a twelfth aspect is configured such that, in the measuring device of any one of the first to ninth aspects, the driving part independently moves the second imaging unit and the first imaging unit with respect to the table at least in the directions of the Z-axis and the Y-axis.

The measuring device of a thirteenth aspect is configured such that, in the measuring device of any one of the first to ninth aspects, the driving part further rotates the table.

In order to accomplish the above object, a machining device of a first aspect includes the measuring device of any one of the first to thirteenth aspects, a machining part configured to machine the workpiece on the table, and a machining control unit configured to control machining by the machining part.

The machining device of a second aspect is configured such that, in the machining device of the first aspect, the machining control unit performs alignment of the workpiece based on the image taken by the first imaging unit.

The presently disclosed subject matter can accurately measure the shape and/or roughness of the surface of a workpiece.

### BRIEF DESCRIPTION OF THE DRAWINGS

FIG. 1 is a schematic configuration diagram of a first embodiment of a measuring device;

FIG. 2 illustrates a schematic configuration of a first imaging unit;

FIG. 3 illustrates a schematic configuration of a second imaging unit;

FIG. 4 illustrates a schematic configuration of a driving system of the measuring device;

FIG. 5 is a block diagram of functions included in an image processing unit;

FIG. 6 is a conceptual diagram of detection of a measurement position;

FIG. 7 illustrates an example of a measurement result of a cut groove on a wafer using a white light interferometer;

FIG. 8 is a flowchart illustrating a flow of measurement by the measuring device;

FIG. 9 is a block diagram of functions included in the image processing unit;

FIG. 10 illustrates a schematic configuration of the first imaging unit;

FIG. 11 is a block diagram of the functions included in the image processing unit;

FIG. 12 is a flowchart illustrating the flow of measurement by the measuring device;

FIG. 13 illustrates a schematic configuration of a machining part in a dicing device;

FIG. 14 is a block diagram of a control system of the machining part in the dicing device; and

FIG. 15 is a flowchart illustrating a processing flow of machining and measuring a wafer by the dicing device.

### DETAILED DESCRIPTION OF THE EMBODIMENTS

Embodiments of the presently disclosed subject matter are described below with reference to the accompanying drawings.

[Measuring Device]

### First Embodiment

Here, an example of measuring a shape of a cut groove (kerf) produced by machining a surface of a semiconductor wafer with a dicing device is described.

[Device Configuration]

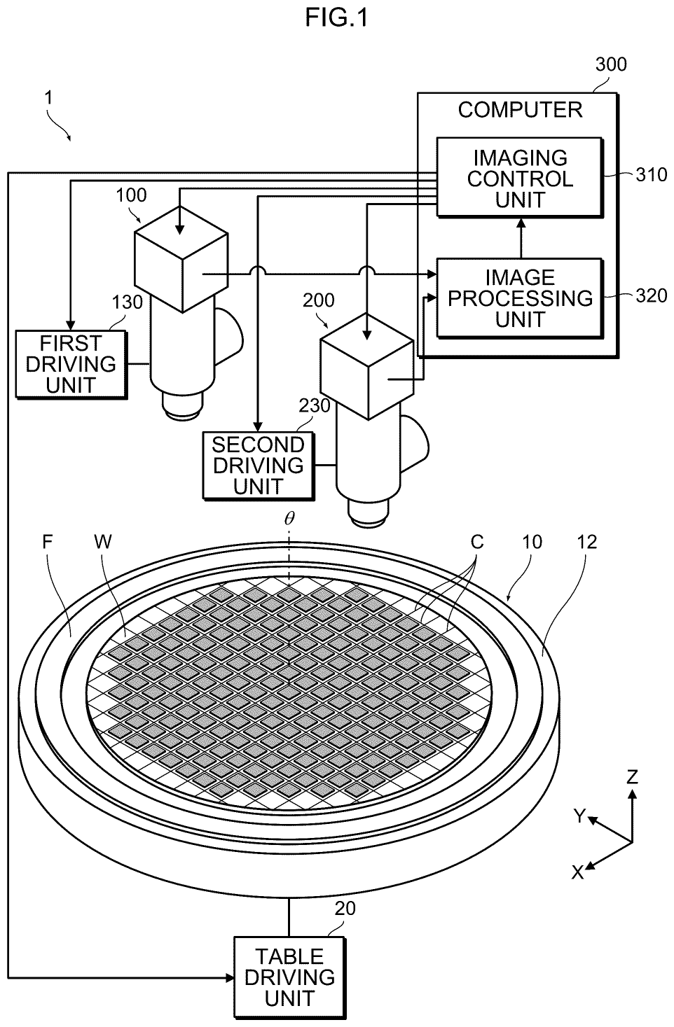

FIG. 1 is a schematic configuration diagram of a first embodiment of a measuring device.

As illustrated in FIG. 1, a measuring device 1 of the present embodiment includes a table 10 on which a wafer W is to be mounted, a table driving unit 20 which rotates the table 10, a first imaging unit 100 which images the wafer W on the table 10, a second imaging unit 200 which images the wafer W on the table 10, a first driving unit 130 which moves the first imaging unit 100, a second driving unit 230 which moves the second imaging unit 200, an imaging control unit 310 which controls the first imaging unit 100, the second imaging unit 200, the table driving unit 20, the first driving unit 130, and the second driving unit 230 so as to control imaging by the first imaging unit 100 and the second imaging unit 200, and an image processing unit 320 which processes images taken by the first imaging unit 100 and the second imaging unit 200. In FIG. 1, an X-axis, a Y-axis, and a Z-axis are orthogonal to each other and constitute a three-dimensional orthogonal coordinate system.

As described above, a workpiece to be measured is the wafer W after dicing. The wafer W is mounted on a dicing frame F and is subjected to machining. The wafer W after machining has a cut groove C produced by machining along a street.

[Table]

The table 10 holds the wafer W on a plane which is parallel to the X-axis and the Y-axis. The table 10, which has a disc-like shape, includes a mounting surface 12 on which the wafer W is mounted. The mounting surface 12 is constituted of a plane parallel to the X-axis and Y-axis.

[Table Driving Unit]

The table driving unit 20, which includes a motor, rotates the table 10 around an 0 axis. The 0 axis is constituted of an axis which extends through the center of the table 10 and which is parallel to the Z-axis.

[First Imaging Unit]

The first imaging unit 100 images the surface of the wafer W on the table 10. For example, in the present embodiment, the first imaging unit 100 takes a magnified image of some part of the surface of the wafer W on the table 10 (takes a so-called microscopic image). The first imaging unit 100 is used to detect a measurement position (the position of an area to be measured). The first imaging unit 100 images the surface of the wafer W (the surface where the cut groove C is produced by machining) from above the table 10, along the direction of the Z-axis.

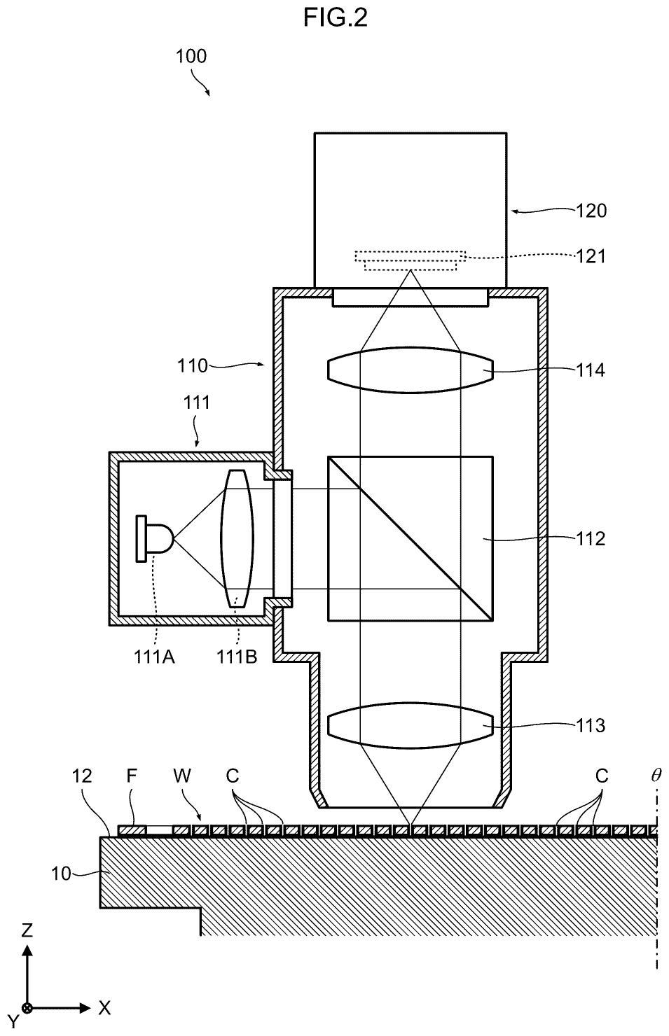

FIG. 2 illustrates a schematic configuration of the first imaging unit.

The first imaging unit 100 includes a first microscope unit 110 and a first camera unit 120. In the first imaging unit 100, the first microscope unit 110 magnifies some part of the surface of the wafer W, and the first camera unit 120 takes an image that is magnified by the first microscope unit 110.

The first microscope unit 110 includes an illumination part 111, a beam splitter 112, an objective lens 113, an image forming lens 114 and the like.

The illumination part 111 includes an illumination light source 111A and an illumination lens 111B. The illumination part 111 outputs light (illumination light) which is emitted from the illumination light source 111A through the illumination lens 1111B. Examples of the illumination light source 111A include halogen lamps, metal halide lamps, mercury lamps, xenon lamps, and light emitting diodes (LEDs).

The wafer W on the table 10 is irradiated with the light output from the illumination part 111 through the beam splitter 112 and the objective lens 113. The light reflected on the wafer W is then incident on the first camera unit 120 through the objective lens 113, the beam splitter 112, and the image forming lens 114.

The first camera unit 120, which includes an image element 121, electronically takes an image of the wafer W. Examples of the image element 121 include area image sensors, such as complementary metal oxide semiconductor (CMOS) image sensors, and charge-coupled device (CCD) image sensors. An image taken by the first camera unit 120 is output to the image processing unit 320.

Images different in focal position can be taken by imaging the wafer W on the table 10 while moving the first imaging unit 100 along the direction of the Z-axis.

The first imaging unit 100 images the surface of the wafer W with a relatively wider visual field than that of the second imaging unit 200. Therefore, the objective lens 113 of the first microscope unit 110 has a relatively lower magnification (wider visual field) than an objective lens 213 of a second microscope unit 210.

In the first embodiment, the first imaging unit 100 is configured to image the surface of the wafer W with a relatively wider visual field than the second imaging unit 200. However, without being limited thereto, the first imaging unit 100 may have the same visual field as that of the second imaging unit 200.

[Second Imaging Unit]

The second imaging unit 200 is an imaging part for measurement. The second imaging unit 200 images the surface of the wafer W with the optical interference system. In the present embodiment in particular, the surface of the wafer W is imaged by white light interferometry using white light as a light source. By scanning and imaging the surface of the wafer W in the Z-axis direction using the white light interferometry, unevenness (the shape and/or roughness) of the surface of the wafer W can be measured. Since the surface of the wafer W is imaged by the white light interferometry, the second imaging unit 200 includes a white light interferometer.

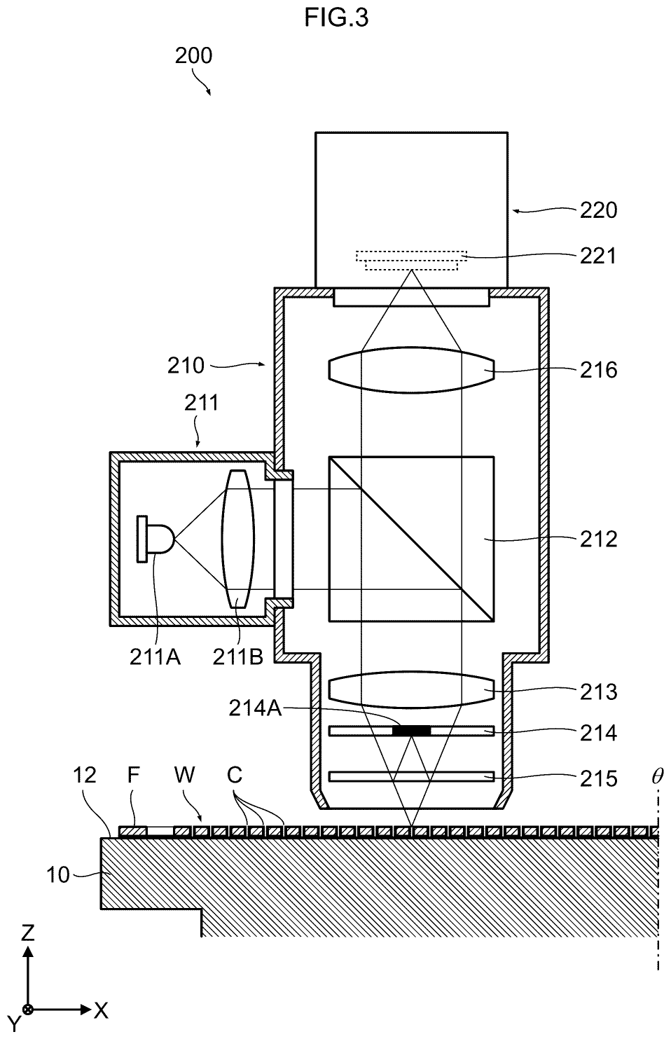

FIG. 3 illustrates a schematic configuration of the second imaging unit.

The second imaging unit 200 includes the second microscope unit 210 and a second camera unit 220. In the second imaging unit 200, the second camera unit 220 takes an image (interference image) observed with the second microscope unit 210. The second imaging unit 200 images the surface of the wafer W from above the table 10 along the direction of the Z-axis.

The second microscope unit 210 includes a white interference microscope. In the present embodiment, the second microscope unit 210 includes a so-called Mirau interference-type white interference microscope. As illustrated in FIG. 3, the second microscope unit 210 includes an illumination part 211, a first beam splitter 212, an objective lens 213, a glass plate 214, a second beam splitter 215, an image forming lens 216 and the like. The glass plate 214 has a reference mirror 214A in a central portion. The objective lens 213, the glass plate 214 and the second beam splitter 215 constitute an interference optical system.

The illumination part 211 includes a white light source 211A and an illumination lens 211B. The illumination part 211 outputs white light which is emitted from the white light source 211A through the illumination lens 211B. Examples of the white light source 211A may include a halogen lamp and an LED.

The white light output from the illumination part 211 is made incident on the second beam splitter 215 through the first beam splitter 212, the objective lens 213, and the glass plate 214. The white light incident on the second beam splitter 215 is split to measurement light and reference light by the second beam splitter 215.

The measurement light passes through the second beam splitter 215 and enters the surface of the wafer W. Then, the measurement light reflected on the surface of the wafer W is made incident on the second camera unit 220 through the second beam splitter 215, the glass plate 214, the objective lens 213, the first beam splitter 212, and the image forming lens 216.

The reference light is reflected by the second beam splitter 215 and is made incident on the glass plate 214. The reference light incident on the glass plate 214 is reflected by the reference mirror 214A and is again made incident on the second beam splitter 215. Then, the reference light is reflected again on the second beam splitter 215, and is made incident on the second camera unit 220 through the glass plate 214, the objective lens 213, the first beam splitter 212, and the image forming lens 216.

When the measurement light which is reflected on the surface of the wafer W and incident on the second camera unit 220 overlaps with the reference light which is reflected on the reference mirror 214A and incident on the second camera unit 220, interference light is generated. The interference optical system including the objective lens 213, the glass plate 214, and the second beam splitter 215 is designed so that the measurement light and the reference light are equal in optical path length when an object to be measured is in focus.

The second camera unit 220 includes an imaging element 221 which electronically takes an image (interference image) generated by the second microscope unit 210. Examples of the imaging element 221 include area image sensors such as CMOS image sensors and CCD image sensors. An image taken by the second camera unit 220 is output to the image processing unit 320.

When the second imaging unit 200 is moved along the direction of the Z-axis, the optical path length of the measurement light, which is reflected on the surface of the wafer W, changes. When the optical path lengths match each other, the generated interference light incident on the imaging element 221 has a maximum interference intensity. Therefore, the position of the unevenness on the surface of the wafer W can be measured by reading the position in the Z-axis direction where the interference intensity is maximum for each pixel.

[First Driving Unit]

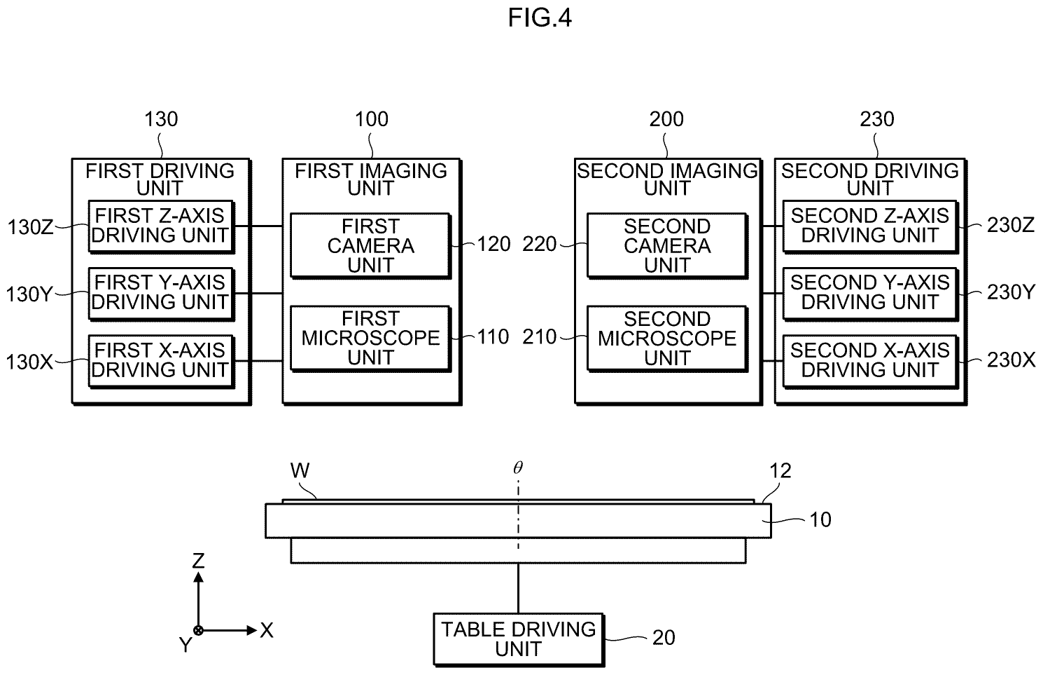

FIG. 4 illustrates a schematic configuration of a drive system of the measuring device.

The first driving unit 130 and the second driving unit 230 independently move the first imaging unit 100 and the second imaging unit 200 along the directions of the X-axis, the Y-axis, and the Z-axis, respectively.

As illustrated in FIG. 4, the first driving unit 130 includes a first X-axis driving unit 130X which moves the first imaging unit 100 along the X-axis direction, a first Y-axis driving unit 130Y which moves the first imaging unit 100 along the Y-axis direction, and a first Z-axis driving unit 130Z which moves the first imaging unit 100 along the Z-axis direction. As an example, the measuring device 1 of the present embodiment includes a first X-axis carriage which moves along the X-axis direction with respect to a base, a first Y-axis carriage which moves along the Y-axis direction with respect to the first X-axis carriage, a first Z-axis carriage which moves along the Z-axis direction with respect to the first Y-axis carriage. The first imaging unit 100 is mounted on the first Z-axis carriage. The first X-axis driving unit 130X moves the first X-axis carriage along the X-axis direction to move the first imaging unit 100 in the X-axis direction. The first Y-axis driving unit 130Y moves the first Y-axis carriage along the Y-axis direction to move the first imaging unit 100 in the Y-axis direction. The first Z-axis driving unit 130Z moves the first Z-axis carriage along the Z-axis direction to move the first imaging unit 100 in the Z-axis direction. This makes it possible to move the first imaging unit 100 in the X-axis, Y-axis, and Z-axis directions. The respective driving parts have their own position sensors, and the respective position sensors detect the positions of the corresponding carriages (the positions in the respective axis directions). Hence, the first X-axis driving unit 130X detects the position of the first X-axis carriage in the X-axis direction. The first Y-axis driving unit 130Y detects the position of the first Y-axis carriage in the Y-axis direction. The first Z-axis driving unit 130Z detects the position of the first Z-axis carriage in the Z-axis direction. Based on the positions of the respective carriages detected by the corresponding position sensors, the position of the first imaging unit 100 in each axis direction with respect to the table 10 is detected.

[Second Driving Unit]

The second driving unit 230 is similar in configuration to the first driving unit 130. As illustrated in FIG. 4, the second driving unit 230 also includes a second X-axis driving unit 230X which moves the second imaging unit 200 along the X-axis direction, a second Y-axis driving unit 230Y which moves the second imaging unit 200 along the Y-axis direction, and a second Z-axis driving unit 230Z which moves the second imaging unit 200 along the Z-axis direction. The measuring device 1 includes a second X-axis carriage which moves along the X-axis direction with respect to the base, a second Y-axis carriage which moves along the Y-axis direction with respect to the second X-axis carriage, and a second Z-axis carriage which moves along the Z-axis direction with respect to the second Y-axis carriage. The second imaging unit 200 is mounted on the second Z-axis carriage. The second X-axis driving unit 230X moves the second X-axis carriage along the X-axis direction to move the second imaging unit 200 in the X-axis direction. The second Y-axis driving unit 230Y moves the second Y-axis carriage along the Y-axis direction to move the second imaging unit 200 in the Y-axis direction. The second Z-axis driving unit 230Z moves the second Z-axis carriage along the Z-axis direction to move the second imaging unit 200 in the Z-axis direction. This makes it possible to move the second imaging unit 200 in the X-axis, Y-axis, and Z-axis directions. The respective driving parts have their own position sensors, and the respective position sensors detect the positions of the corresponding carriages (the positions in the respective axis directions). Hence, the second X-axis driving unit 230X detects the position of the second X-axis carriage in the X-axis direction. The second Y-axis driving unit 230Y detects the position of the second Y-axis carriage in the Y-axis direction. The second Z-axis driving unit 230Z detects the position of the second Z-axis carriage in the Z-axis direction. Based on the positions of the respective carriages detected by the corresponding position sensors, the position of the second imaging unit 200 in each axis direction with respect to the table 10 is detected.

[Imaging Control Unit]

The imaging control unit 310 controls the first imaging unit 100, the second imaging unit 200, the table driving unit 20, the first driving unit 130, and the second driving unit 230 so as to control imaging by the first imaging unit 100 and the second imaging unit 200.

The imaging control unit 310 may be implemented by, for example, a computer 300 including a processor and a memory. Here, the computer 300 executes a prescribed program to function as the imaging control unit 310.

The imaging control unit 310 controls the first imaging unit 100 to perform imaging to detect the measurement position. The imaging control unit 310 also controls the first imaging unit 100 to perform imaging to detect the position of the surface of the wafer W. The imaging control unit 310 also controls the second imaging unit 200 to perform imaging to measure the shape of the surface of the wafer W. The imaging control unit 310 controls imaging as described later in detail.

[Image Processing Unit]

The image processing unit 320 processes images taken by the first imaging unit 100 and the second imaging unit 200. Like the imaging control unit 310, the image processing unit 320 may be implemented by the computer 300. Here, the computer 300 executes a prescribed program to function as the image processing unit 320.

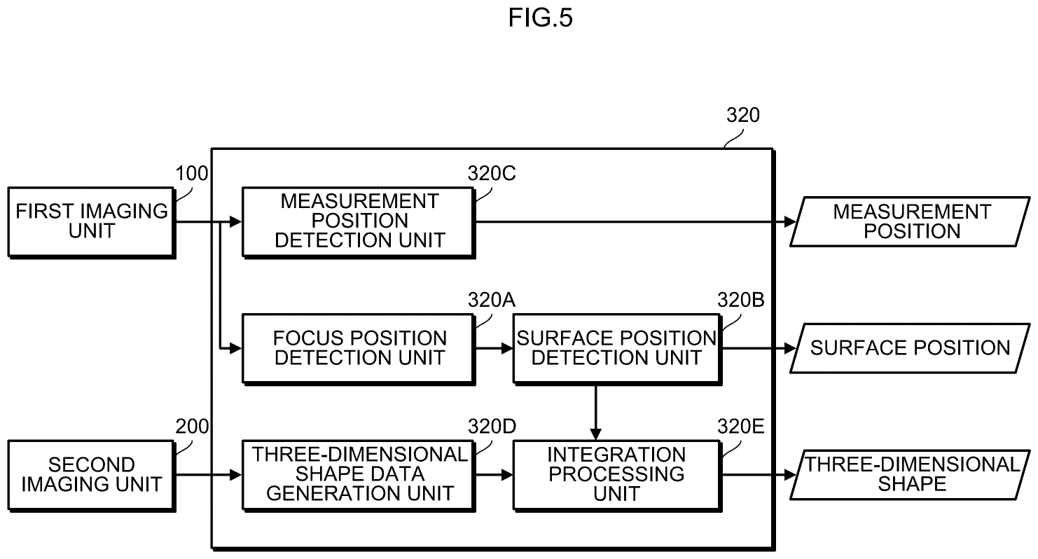

FIG. 5 is a block diagram of functions included in the image processing unit.

As illustrated in FIG. 5, the image processing unit 320 has the functions of a focus position detection unit 320A, a surface position detection unit 320B, a measurement position detection unit 320C, a three-dimensional shape data generation unit 320D, an integration processing unit 320E, and the like.

The focus position detection unit 320A detects a focus position (a position in focus) from images taken by making the first imaging unit 100 perform scanning in the Z-axis direction. As an example, in the present embodiment, evaluation values of a focusing degree are calculated based on the images taken by making the first imaging unit 100 perform scanning in the Z-axis direction, and the position having a peak evaluation value is detected as the focus position. The focusing degree is a numerical value indicating the degree of focus. For the focusing degree, an image contrast may be adopted. Hence, an auto-focus technique with a contrast system is adopted.

The surface position detection unit 320B detects the position (a height position) of the surface of the wafer W in the Z-axis direction, based on the detection result of the focus position when the surface of the wafer W is in focus. Since the positional relationship between the mounting surface 12 of the table 10 and the first imaging unit 100 is known, the position of the surface of the wafer W can be detected from the detection result of the focus position when the surface of the wafer W is in focus. Hence, the surface position detection unit 320B detects the position of the surface of the wafer W from a Z-axis position of the first imaging unit 100 when the surface of the wafer W is in focus.

In the present embodiment, a combination of the focus position detection unit 320A and the surface position detection unit 320B is an example of the first image processing unit.

The measurement position detection unit 320C detects the position (a measurement position) of an area as an object to be measured (a measurement object area) from an image (a so-called microscope image) taken by the first imaging unit 100.

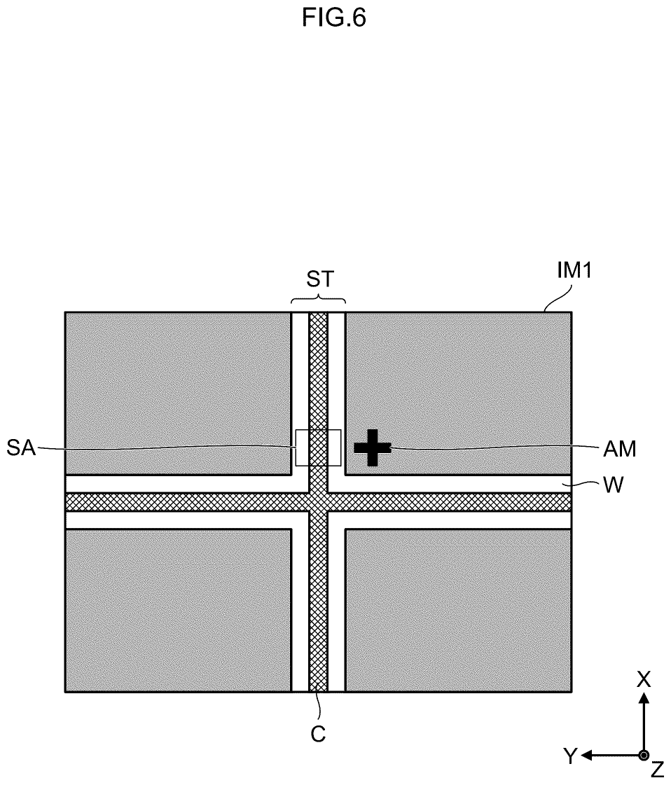

FIG. 6 is a conceptual diagram of detection of the measurement position.

As described above, in this embodiment, a cut groove C produced by machining the surface of the wafer W is an object to be measured. Therefore, the area including the cut groove C is set as a measurement object area SA. The example illustrated in FIG. 6 indicates an example where the measurement object area SA is set at a specific position on a street ST with an alignment mark AM as a reference. The alignment mark AM is a mark (also known as an alignment target) which is imparted to the surface of the wafer W for alignment purposes. The street ST is the area which can be cut on the wafer W.

The measurement position detection unit 320C detects the alignment mark AM from an image IM1 taken by the first imaging unit 100 and detects the measurement position (for example, the position of the center of the measurement object area SA). Accordingly, the measurement position detection unit 320C detects the measurement position set based on the alignment mark AM.

The three-dimensional shape data generation unit 320D generates three-dimensional shape data on the object to be measured (the cut groove C in the present embodiment) based on the image taken by making the second imaging unit 200 perform scanning in the Z-axis direction. As described above, the second imaging unit 200 includes a white interferometer. Accordingly, the measurement object area is imaged by scanning in the Z-axis direction, and a resultant image (inference image) can be used to measure the three-dimensional shape of the measurement object area. In the present embodiment, the three-dimensional shape data generation unit 320D is an example of the second image processing unit.

The integration processing unit 320E integrates the processing result of the three-dimensional shape data generation unit 320D with the processing results of the focus position detection unit 320A and the surface position detection unit 320B to calculate a final three-dimensional shape of the object to be measured. Hence, the integration processing unit 320E calculates the final three-dimensional shape based on the three-dimensional shape data generated in the three-dimensional shape data generation unit 320D and the information on the surface position detected by the surface position detection unit 320B.

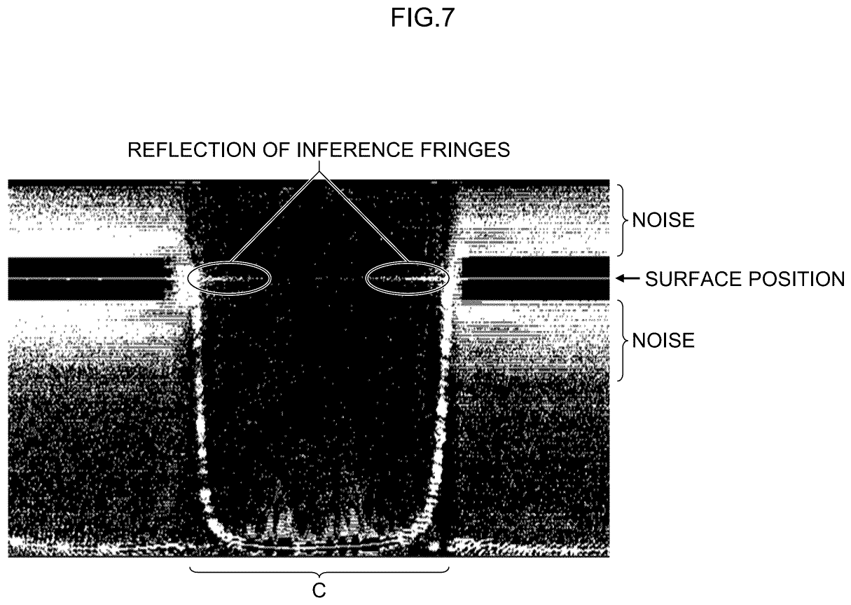

FIG. 7 illustrates an example of the measurement result of the cut groove on the wafer by the white interferometer. FIG. 7 illustrates three-dimensional shape data projected on a two-dimensional cross-section (a cross-section of the cut groove C).

As illustrated in FIG. 7, noise may be generated in the vicinity of the surface of the wafer W during measurement by the white interferometer. The noise causes instability and false detection at the time of extracting the original shape of the surface.

As described above, the measuring device 1 of the present embodiment can detect the surface position of the wafer W based on the result of imaging by the first imaging unit 100. Therefore, using the information on the surface position makes it possible to separate noise components in the vicinity of the surface from the measurement data (three-dimensional shape data) obtained by the white interferometer, so that the surface position can be specified accurately.

The integration processing unit 320E specifies, for the three-dimensional shape data generated by the three-dimensional shape data generation unit 320D, the position detected by the surface position detection unit 320B as the surface position of the wafer W, and calculates the measurement result of the final three-dimensional shape.

The information on the measurement result of the final three-dimensional shape calculated in the integration processing unit 320E is output to (is displayed on) a display device (not illustrated) connected to the computer 300. The information is also recorded on a storage device (not illustrated) included in the computer 300 as necessary.

[Measurement Procedure]

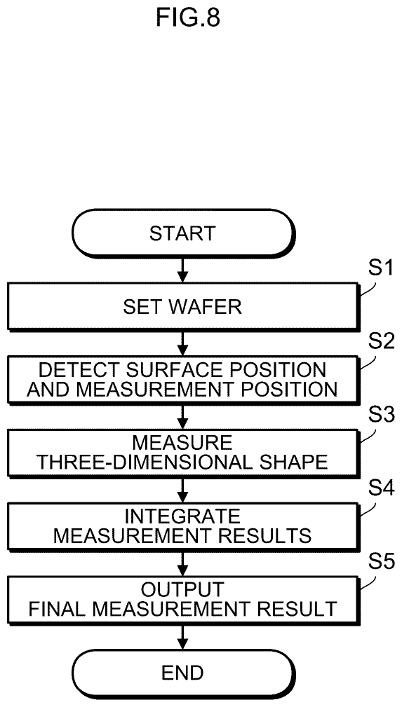

FIG. 8 is a flowchart illustrating the flow of measurement by the measuring device.

First, the wafer W as an object to be measured is set on the table 10 (step S1). The wafer W to be measured is the wafer W after dicing.

Next, the first imaging unit 100 is used to detect the surface position and the measurement position of the wafer W (step S2). The surface position of the wafer W is detected by making the first imaging unit 100 perform scanning in the Z-axis direction and focusing on the surface of the wafer W. The measurement position is detected by detecting the alignment mark AM from the image taken by the first imaging unit 100. The imaging control unit 310 moves the first imaging unit 100 in the X-axis direction and the Y-axis direction as necessary to detect the alignment mark AM.

Next, the second imaging unit 200 is used to measure the three-dimensional shape of the measurement object area SA (step S3). Hence, the second imaging unit 200 is made to perform scanning in the Z-axis direction to take inference images at the measurement position. The imaging control unit 310 moves the second imaging unit 200 to the measurement position based on the detection result of the measurement position. If necessary, the imaging control unit 310 rotates the table 10 to correct the orientation (the rotation angle) of the wafer W. Accordingly, the imaging control unit 310 corrects the orientation of the wafer W so that the cut groove C to be measured is disposed along the direction of the X-axis. The imaging control unit 310 further sets a scanning range in the Z-axis direction, based on the detection result of the surface position. Specifically, the imaging control unit 310 sets the scanning range with a position away by a prescribed distance from the surface position of the wafer W as a starting point. The three-dimensional shape data on the measurement object area SA is generated from interference images obtained by the measurement.

Next, the measurement result of the three-dimensional shape (three-dimensional shape data) using the second imaging unit 200 and the detection result of the surface position using the first imaging unit 100 are integrated, and the final three-dimensional shape of the object to be measured is calculated (step S4). As described above, the final three-dimensional shape is calculated by specifying the surface position of the wafer W detected by the first imaging unit 100 as the surface position of the wafer W for the measurement result of the three-dimensional shape (the three-dimensional shape data) using the second imaging unit 200.

The integrated measurement result is output to the display device as the measurement result of the final three-dimensional shape (step S5).

As described in the foregoing, the measuring device 1 of the present embodiment can accurately measure the shape of the groove of the wafer W by making effective use of the information (the information on the surface position of the wafer W) obtained from the first imaging unit 100. In addition, the measuring device 1 of the present embodiment can easily set the scanning range of the second imaging unit 200 by making effective use of the information (the information on the surface position of the wafer W) obtained from the first imaging unit 100. Furthermore, the measuring device 1 of the present embodiment can easily detect the measurement position by using the first imaging unit 100. Hence, the first imaging unit 100 can easily detect the measurement position since it has a wider visual field than the second imaging unit 200.

### Second Embodiment

The measuring device 1 of the first embodiment is configured such that the first imaging unit 100 detects the surface position of the wafer W, and the detection result thereof is reflected upon the result of measurement using the second imaging unit 200. In a measuring device of the present embodiment, the first imaging unit 100 further detects an edge of the cut groove C, and the detection result is reflected upon the measurement result using the second imaging unit 200.

When the surface with a steep unevenness, such as the cut groove C, is measured with a white light interferometer, reflection of interference fringes may be generated in the vicinity of an edge of the surface (a boundary between the street ST and the cut groove C) as illustrated in FIG. 7. For example, in the example illustrated in FIG. 7, the reflection of interference fringes is generated from the edge to the inside of the cut groove C (an area where originally no object is present) in the vicinity of the surface. In the measurement with the white light interferometer, the reflection of the interference fringes causes instability and false detection in the case of extracting the original surface shape (in this case, the edge).

Accordingly, the measuring device of the present embodiment extracts the edge of the cut groove C from the image taken by the first imaging unit 100 and reflects the extraction result upon the result of measurement using the second imaging unit 200. Hence, the edge of the cut groove C is specified using the result of measurement using the first imaging unit 100.

The basic configuration of the device is the same as the measuring device 1 of the aforementioned first embodiment. Therefore, the differences (for example, the configuration of the image processing unit 320) are described below.

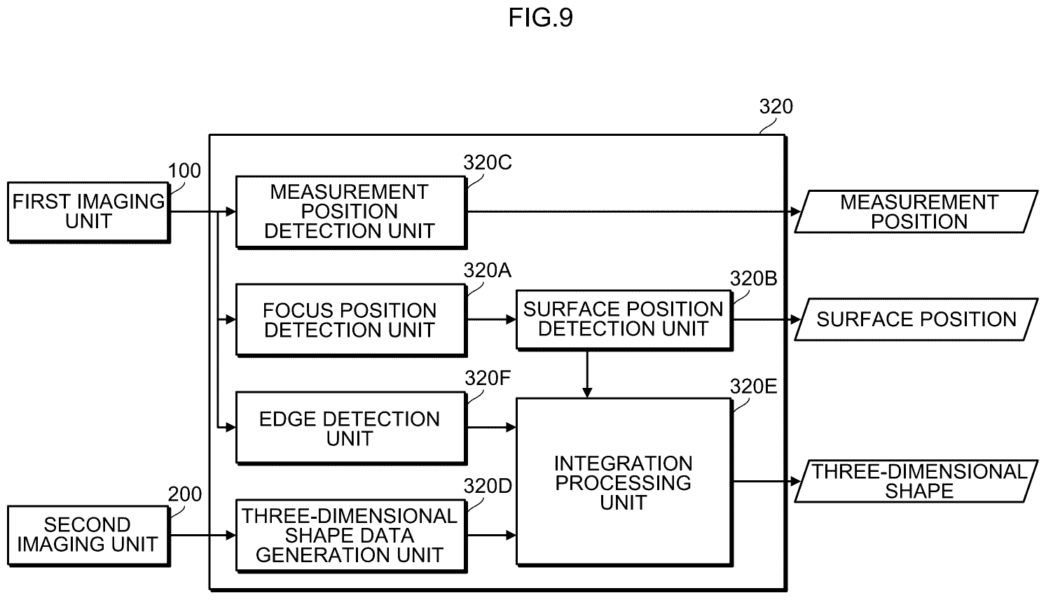

FIG. 9 is a block diagram of the functions included in the image processing unit.

As illustrated in FIG. 9, the image processing unit 320 in the present embodiment further has the function of an edge detection unit 320F.

The edge detection unit 320F detects the edge from the image taken by the first imaging unit 100. When the cut groove C is an object to be measured, the boundary between the cut groove C and the street ST is detected as an edge. As a method of detecting the edge from an image, a well-known image processing technique can be adopted. As the image to be processed, the image taken by focusing on the surface of the wafer W is adopted. The detection result of the edge is input into the integration processing unit 320E. In the present embodiment, the edge detection unit 320F is another example of the first image processing unit.

The integration processing unit 320E calculates the measurement result of the final three-dimensional shape, based on the three-dimensional shape data generated in the three-dimensional shape data generation unit 320D, the information on the surface position detected by the surface position detection unit 320B, and edge information detected by the edge detection unit 320F. Specifically, for the three-dimensional shape data generated in the three-dimensional shape data generation unit 320D, the position detected by the surface position detection unit 320B is specified as the surface position. In addition, an edge portion is specified based on the edge detected by the edge detection unit 320F. This makes it possible to eliminate the influence of noise generated in the vicinity of the surface and the influence of the interference fringes reflected on the inside of the cut groove C in the vicinity of the edge and thereby measure the shape of the cut groove C with high accuracy.

### Third Embodiment

A measuring device of the present embodiment uses both the first imaging unit 100 and the second imaging unit 200 to measure the three-dimensional shape, and integrates both the measurement results to calculate a final measurement result.

The first imaging unit 100 measures the three-dimensional shape of the surface of the wafer W by a focus variation method (also referred to as a focus shift method or a focus method). In the focus variation method, images of an object to be measured, which are different in focal position, are taken, and the three-dimensional shape of the object to be measured is measured based on the degree of focusing in each pixel. Specifically, the three-dimensional shape of the object to be measured is measured by calculating an evaluation value of the focusing degree of each pixel based on each of the obtained images, specifying the focal position at which the calculated evaluation value is the highest, and thereby specifying the height (the position in the Z-axis direction) of the object to be measured at the position corresponding to each pixel.

The second imaging unit 200 measures the three-dimensional shape of the surface of the wafer W by the white light interferometry, as in the case of the measuring device 1 of the first embodiment.

The basic configuration of the device is the same as the measuring device 1 of the first embodiment except for the point that the first imaging unit 100 measures the three-dimensional shape. Therefore, only the differences (the first imaging unit 100 and the image processing unit 320) are described below.

[First Imaging Unit]

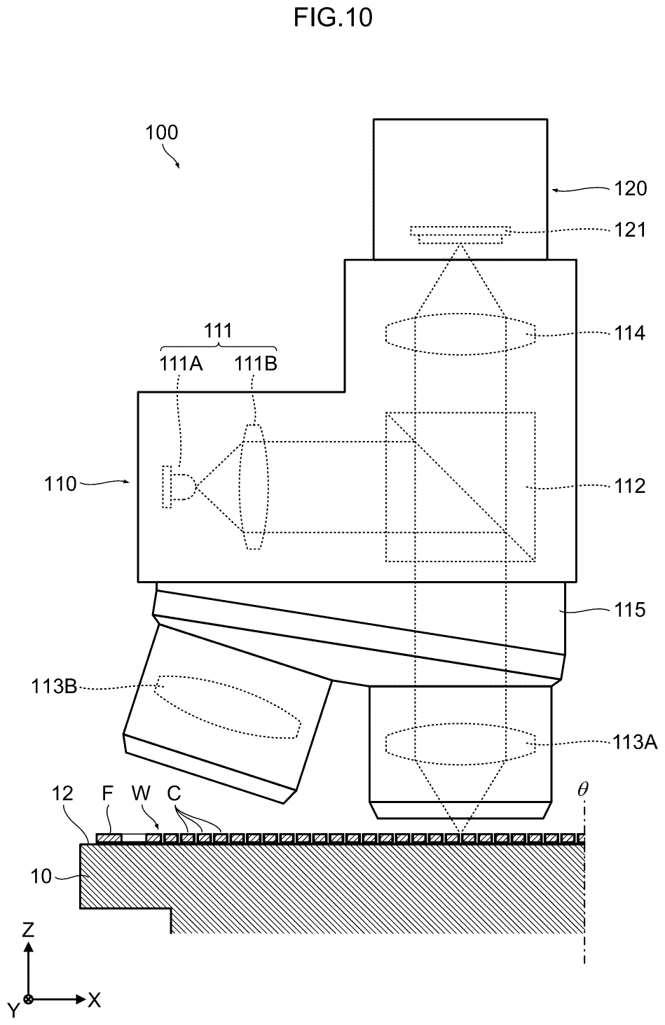

FIG. 10 illustrates a schematic configuration of the first imaging unit.

The first imaging unit 100 of the present embodiment includes two objective lenses different in magnification (a first objective lens 113A and a second objective lens 113B). The first objective lens 113A and the second objective lens 113B are attached to a barrel of the first microscope unit 110 via an electric revolver 115. By rotating the revolver 115, the objective lens to be used is switched.

The first objective lens 113A with a low magnification is used to detect the measurement position. The second objective lens 113B with a high magnification is used for measurement. Hence, the second objective lens 113B is used for measurement of the three-dimensional shape by the focus variation method.

[Image Processing Unit]

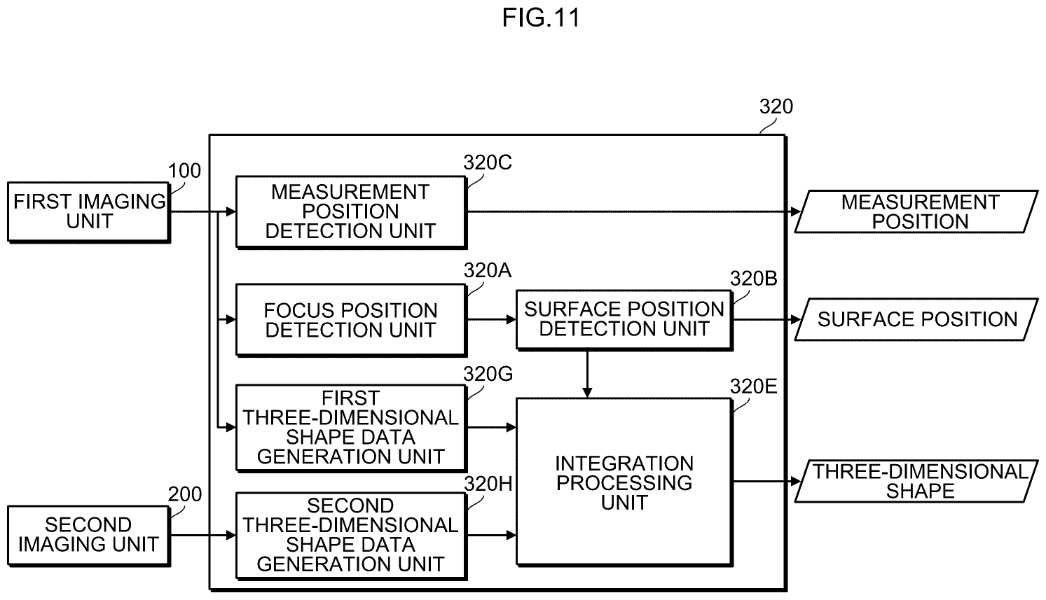

FIG. 11 is a block diagram of the functions included in the image processing unit.

As illustrated in FIG. 11, the image processing unit 320 has the functions of a first three-dimensional shape data generation unit 320G and a second three-dimensional shape data generation unit 320H.

The first three-dimensional shape data generation unit 320G generates three-dimensional shape data on the object to be measured based on the images taken by making the first imaging unit 100 perform scanning in the Z-axis direction. Specifically, the first three-dimensional shape data generation unit 320G generates the three-dimensional shape data on an object to be measured by the focus variation method. As described above, the focus variation method calculates the evaluation value of the focusing degree for each pixel based on each image obtained by Z-axis scanning. Then, the focal position at which the calculated evaluation value is the highest is specified so as to specify the height (the position in the Z-axis direction) of the object to be measured at the position corresponding to each pixel, and thereby the three-dimensional shape data is generated. As described above, the measurement is performed using the second objective lens 113B with a high magnification. In the present embodiment, the first three-dimensional shape data generation unit 320G is another example of the first image processing unit.

The second three-dimensional shape data generation unit 320H generates three-dimensional shape data on the object based on the images taken by making the second imaging unit 200 perform scanning in the Z-axis direction. The function of the second three-dimensional shape data generation unit 320H is the same as that of the three-dimensional shape data generation unit 320D in the first embodiment. Hence, the second three-dimensional shape data generation unit 320H generates the three-dimensional shape data on the object to be measured based on the images (interference images) obtained by the Z-axis scanning. In the present embodiment, the second three-dimensional shape data generation unit 320H is another example of the second image processing unit.

The integration processing unit 320E integrates the three-dimensional shape data generated in the first three-dimensional shape data generation unit 320G and the second three-dimensional shape data generating part 320H to calculate the final three-dimensional shape data on the objected to be measured.

As described above, noise may be generated in the vicinity of the surface of the wafer W with the white light interferometer. In addition, the reflection of interference fringes may be generated in the vicinity of the edge of the surface.

Therefore, in the present embodiment, the three-dimensional shape data generated in the first three-dimensional shape data generation unit 320G is used for the shape of the surface including the edge (the shape of a portion of the street ST), and the three-dimensional shape data generated in the second three-dimensional shape data generation unit 320H is used for the shape inside the cut groove C, to calculate the final three-dimensional shape data. As a result, the shape of the cut groove C can be measured with high accuracy.

[Measurement Procedure]

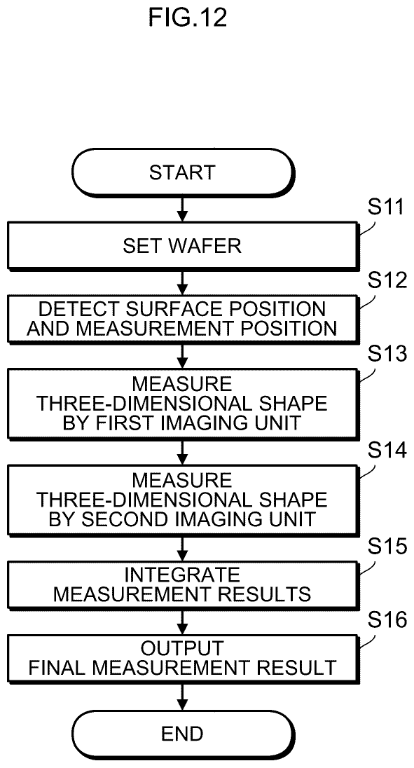

FIG. 12 is a flowchart illustrating a flow of measurement by the measuring device.

First, the wafer W as an object to be measured is set on the table 10 (step S11).

Next, the first imaging unit 100 is used to detect the surface position and the measurement position of the wafer W (step S12). In this case, the first objective lens 113A with a low magnification is used. Hence, the objective lens with a wider visual field is used. This makes it easier to detect the measurement position.

Next, the first imaging unit 100 is used to measure the three-dimensional shape of the measurement object area SA (step S13). Hence, the first imaging unit 100 is made to perform scanning in the Z-axis direction to take images at the measurement position. The imaging control unit 310 moves the first imaging unit 100 to the measurement position based on the detection result of the measurement position. If necessary, the imaging control unit 310 rotates the table 10 to correct an angle of the wafer W. The imaging control unit 310 further sets a scanning range in the Z-axis direction, based on the detection result of the surface position. Specifically, the imaging control unit 310 sets the scanning range with a position away by a prescribed distance from the surface position of the wafer W as a starting point. The three-dimensional shape data on the measurement object area SA is generated from images (images different in focal position) obtained by the measurement.

Next, the second imaging unit 200 is used to measure the three-dimensional shape of the measurement object area SA (step S14). Hence, the second imaging unit 200 is made to perform scanning in the Z-axis direction to take inference images at the measurement position. The imaging control unit 310 moves the second imaging unit 200 to the measurement position based on the detection result of the measurement position. The imaging control unit 310 also sets a scanning range in the Z-axis direction, based on the detection result of the surface position. The three-dimensional shape data on the measurement object area SA is generated from interference images obtained by the measurement.

Next, the result of measurement using the first imaging unit 100 (three-dimensional shape data using the focus variation method) and the result of measurement using the second imaging unit 200 (three-dimensional shape data using the white light interferometry) are integrated to calculate final three-dimensional shape data (step S15). As described above, in the present embodiment, the result of measurement using the first imaging unit 100 is adopted for the shape of the surface, and the result of measurement by the second imaging unit 200 is adopted for the shape of the inside of the cut groove C.

The integrated measurement result is output to the display device as the measurement result of the final three-dimensional shape (step S16).

As described in the foregoing, the measuring device of the present embodiment uses both the first imaging unit 100 and the second imaging unit 200 to measure the three-dimensional shape of an object to be measured, and integrates both the measurement results to calculate a final three-dimensional shape. As a result, the measurement that one imaging part is not good at can be complemented by the other imaging part, so that highly accurate measurement can be implemented.

[Modifications of Integration of Measurement Results]

The embodiments disclosed are configured such that the result of measurement using the first imaging unit 100 is adopted for the shape of the surface, and the result of measurement by the second imaging unit 200 is adopted for the shape of the inside of the cut groove C in order to calculate the final three-dimensional shape data. A method of integrating the measurement results is not limited to this. Modifications of the method of integrating the measurement results are described below.

When the area to be measured is a smooth surface without any object (smooth surface without texture), the focus variation method is unable to detect the position of the surface. This is because the focus variation method is an algorithm which uses the contrast of an image to determine the focus position, and therefore it is not possible to specify the position in the case of the surface which is smooth without contrast (smooth surface).

On the other hand, even when the surface is constituted of the smooth surface, the white light interferometry allows high-accuracy detection of the surface position.

Accordingly, when the surface is constituted of the smooth surface, the surface is measured by the white light interferometry, while the other areas are measured by the focus variation method. In other words, the measurement result using the second imaging unit 200 is adopted for the surface, and the measurement result using the first imaging unit 100 is adopted for the other areas. This makes it possible to measure the uneven shape of the surface including the smooth surface with high accuracy.

In this example, the measurement result using the first imaging unit 100 is adopted for the areas other than the smooth surface. However, it is also possible to adopt the configuration where the measurement result is more finely divided and used. For example, for the inside of the cut groove C, the result of measurement using the second imaging unit 200 may be adopted. In this case, the result of measurement using the first imaging unit 100 is adopted for the surfaces (the surface with textures) other than the smooth surface.

The height position (the position in the Z-axis direction) of the surface may be obtained by using the information on the surface position of the wafer W detected during detection of the measurement position.

Similarly, the edge may be obtained by extracting an edge from the image taken by the first imaging unit 100 and then using the information on the extracted edge.

### Other Embodiments of Measuring Device

[Object to Be Measured]

In the above embodiments, the case of measuring the wafer W, especially the wafer W after dicing, has been described as an example. However, the workpiece as an object to be measured is not limited to this.

In the above embodiments, the case of measuring the shape of the surface of the wafer W, especially the shape of the cut groove C, has been described as an example. However, items to be measured are not limited to the shape. The presently disclosed subject matter is also applicable to the measurement of the surface roughness.

[First Imaging Unit]

As described in the measuring device of the third embodiment, it is preferable that an imaging magnification can be switched for the first imaging unit 100. The third embodiment is configured such that the revolver 115 is used to switch the objective lens to be used. However, the device which changes the imaging magnification is not limited to the revolver. For example, it is possible to adopt the configuration where an optical path of light, which is incident on the first camera unit 120, is switched so as to switch the objective lens to be used. It is also possible to adopt the configuration where two or more first imaging units different in magnification are provided, and the first imaging unit to be used is switched among them. In addition, the switchable magnifications may not be two, and it is possible to adopt the configuration where three or more magnifications may be switched.

[Second Imaging Unit]

In the above embodiments, the case where the second imaging unit 200 images the surface of the wafer W using the optical interference method, especially the white light interferometry, has been described as an example. However, the configuration of the second imaging unit 200 is not limited to the example. In addition, for example, the second imaging unit 200 may include a laser microscope. The laser microscope is an optical microscope which uses a laser as an illumination source and a confocal system as an optical system. The laser microscope, like the white light interferometer, can measure the unevenness (shape and/or roughness) of the surface of an object to be measured.

It is also possible to adopt other methods of measuring the shape and/or the roughness of the surface using the principle of light interference, similar to the white light interferometry.

[Driving Part]

In the above embodiments, the first imaging unit 100 and the second imaging unit 200 are configured to independently move with respect to the table 10 in each direction of the X-axis, the Y-axis, and the Z-axis. However, the first imaging unit 100 and the second imaging unit 200 may have any configuration as long as they can move relative to the table 10 in each direction of the X-axis, the Y-axis, and the Z-axis. It is possible to adopt the configuration where, for example, the table 10 moves in the X-axis direction, and the first imaging unit 100 and the second imaging unit 200 independently move in each direction of the Y-axis and the Z-axis. It is possible to adopt the configuration where, for example, the table 10 moves in each direction of the X-axis and the Y-axis, and the first imaging unit 100 and the second imaging unit 200 independently move in the direction of the Z-axis. It is further possible to adopt the configuration where the first imaging unit 100 and the second imaging unit 200 are fixed, and the table 10 moves in each direction of the X-axis, the Y-axis, and the Z-axis. In the above embodiments, the table 10 is configured to rotate around the 0 axis. However, the table 10 may be configured not to rotate.

In the above embodiments, the first imaging unit 100 and the second imaging unit 200 are configured to be able to independently move in each direction of the X-axis, the Y-axis, and the Z-axis. However, the first imaging unit 100 and the second imaging unit 200 may be configured to move together.

As in the above embodiments, when the first imaging unit 100 and the second imaging unit 200 are configured to be able to independently move in each direction of the X-axis, the Y-axis, and the Z-axis with respect to the table 10, imaging by the first imaging unit 100 can be performed separately from imaging by the second imaging unit 200, so that an object can be measured efficiently. For example, when there are two or more locations to be measured in one workpiece, detection of the measurement position by the first imaging unit 100 can be performed separately from measurement by the second imaging unit 200, so that efficient measurement can be performed. Hence, the first imaging unit 100 can detect a next position to be measured during measurement by the second imaging unit 200, so that efficient measurement can be performed.

It is preferable that the first imaging unit 100 and the second imaging unit 200 are configured to be able to move independently at least in the Z-axis direction. In this case, the first imaging unit 100 and the second imaging unit 200 may be different in driving accuracy from each other. For example, it is configured such that the second imaging unit 200 can be driven with a relatively higher accuracy than the first imaging unit 100. Since the first imaging unit 100 is used for detecting the measurement position, the first imaging unit 100 has a driving part configured with a relatively lower accuracy so as to achieve quick focusing. On the other hand, since the second imaging unit 200 is used for measurement, the second imaging unit 200 has a driving part configured with a relatively higher accuracy. This makes it possible to shorten the measurement time while achieving high measurement accuracy. The driving part with a high accuracy refers to, for example, the drive part with a high positioning accuracy, the driving part with a high parallel degree in movement, and so on.

[Machining Device]

Here, description is given by taking as an example for the case where the presently disclosed subject matter is applied to a dicing device, especially a blade dicer. The blade dicer is a device which provides the cut groove C by machining a workpiece (a semiconductor wafer W in the present embodiment) by a blade attached to the tip of a spindle which rotates at high speed. The dicing device is an example of the machining device. By incorporating the measuring device according to the presently disclosed subject matter into the dicing device, the shape of the cut groove C produced by machining can be measured inside the device, for example.

The dicing device typically includes a supply part which supplies wafers that are objects to be machined, a machining part which machines the wafers, a cleaning part which cleans the wafers after machining, a collection part to collect the wafers after cleaning and the like. Since the measurement of the wafer W is carried out in the machining part, only the machining part is described below.

[Machining Part]

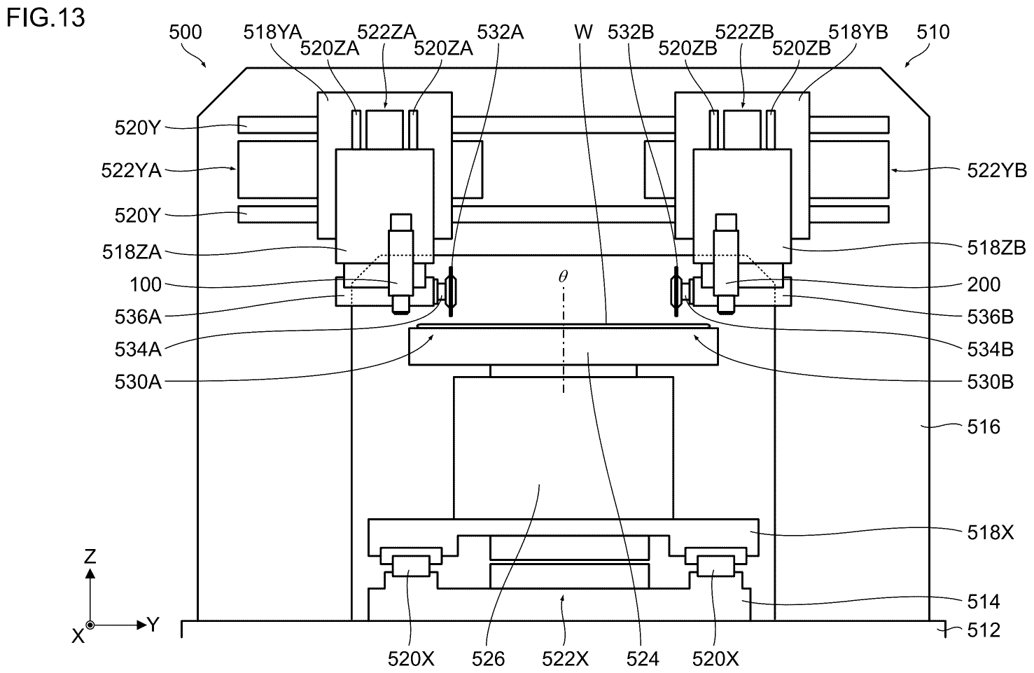

FIG. 13 illustrates a schematic configuration of the machining part in the dicing device.

A dicing device 500 illustrated in FIG. 13 is a dicing device which includes two spindles and which can perform machining of two locations at the same time.

As illustrated in FIG. 13, a machining part 510 of the dicing device 500 includes a saddle 514 and a portal (gate type) column 516 on a base 512.

On the saddle 514, an X-axis carriage 518X which moves on an X-axis guide rail 520X is provided. The X-axis carriage 518X is driven by an X-axis driving unit 522X to move on the X-axis guide rail 520X along the X-axis direction. The X-axis driving unit 522X includes, for example, a linear motor. The position (X-axis position) of the X-axis carriage 518X on a moving shaft is detected by a position sensor which is not illustrated. The position sensor includes, for example, a linear scale.

The X-axis carriage 518X includes a work table 524 and a table driving unit 526 which rotates the work table 524. The work table 524, which has a disk shape, includes a mounting surface having a top surface part on which the wafer W is mounted. The mounting surface is constituted of a plane (horizontal plane) including the X-axis and the Y-axis. For example, the wafer W is suctioned and retained on the mounting surface by vacuum adsorption. The table driving unit 526 includes a motor, which rotates the work table 524 around the 0 axis. The 0 axis extends through the center of the work table 524 and parallel to the Z-axis.

The portal column 516 includes a first Y-axis carriage 518YA and a second Y-axis carriage 518YB, which move on a Y-axis guide rail 520Y. The first Y-axis carriage 518YA and the second Y-axis carriage 518YB are driven by a first Y-axis driving unit 522YA and a second Y-axis driving unit 522YB, respectively, and move independently on the common Y-axis guide rail 520Y along the Y-axis direction. The first Y-axis driving unit 522YA and the second Y-axis driving unit 522YB each includes, for example, a linear motor. The positions (Y axis positions) of the first Y-axis carriage 518YA and the second Y-axis carriage 518YB on their moving shafts are separately detected by their position sensors which are not illustrated. The position sensors each includes, for example, a linear scale.

The first Y-axis carriage 518YA is provided with a first Z-axis carriage 518ZA moving on a first Z-axis guide rail 520ZA. The second Y-axis carriage 518YB is provided with a second Z-axis carriage 518ZB moving on a second Z-axis guide rail 520ZB. The first Z-axis carriage 518ZA and the second Z-axis carriage 518ZB are driven by a first Z-axis driving unit 522ZA and a second Z-axis driving unit 522ZB, respectively, and move on the first Z-axis guide rail 520ZA and the second Z-axis guide rail 520ZB along the Z-axis direction. The first Z-axis driving unit 522ZA and the second Z-axis driving unit 522ZB each includes, for example, a linear motor. The positions (Z axis positions) of the first Z-axis carriage 518ZA and the second Z-axis carriage 518ZB on their moving shafts are detected by their position sensors which are not illustrated. The position sensors each includes, for example, a linear scale.

The first Z-axis carriage 518ZA includes a first machining unit 530A which machines the wafer W on the work table 524. The second Z-axis carriage 518ZB includes a second machining unit 530B which machines the wafer W on the work table 524. The first machining unit 530A includes a spindle 534A having a blade 532A at the tip thereof, and a spindle driving part 536A which rotates the spindle 534A. The second machining unit 530B includes a spindle 534B with a blade 532B at the tip thereof, and a spindle driving part 536B which rotates the spindles 534B. Each of the first machining unit 530A and the second machining unit 530B also includes a cutting fluid supply part (not illustrated) which supplies cutting fluid. The blades 532A and 532B are detachably attached to the respective tips of the spindles 534A and 534B. The spindles 534A and 534B are disposed along the direction of the Y-axis. The spindle driving parts 536A and 536B include motors, and the motors rotate the spindles 534A and 534B, respectively. The cutting fluid supply part, which includes a nozzle, supplies through the nozzle the cutting fluid to contact parts of the blades 532A and 532B with the wafer W.

The first Z-axis carriage 518ZA includes a first imaging unit 100. The first imaging unit 100 is similar in configuration to the first imaging unit 100 in the measuring device 1. The first imaging unit 100 takes a magnified image of the wafer W on the work table 524. The first imaging unit 100 is used for measurement, as well as for alignment of the wafer W during machining.

The second Z-axis carriage 518ZB includes a second imaging unit 200. The second imaging unit 200 is similar in configuration to the second imaging unit 200 of the measuring device 1. Accordingly, the second imaging unit 200 includes a white light interferometer. Therefore, the shape of the surface of the wafer W can be measured by moving the second imaging unit 200 in the Z-axis direction and imaging the wafer W on the work table 524.

The dicing device 500 with the above configuration drives the X-axis driving unit 522X to move the X-axis carriage 518X along the X-axis direction, so that the work table 524 is fed along the X-axis direction. As a result, machining feed of the work table 524 is carried out. In addition, the first Y-axis driving unit 522YA and the second Y-axis driving unit 522YB are driven to move the first Y-axis carriage 518YA and the second Y-axis carriage 518YB along the Y-axis direction, so that the first machining unit 530A and the second machining unit 530B are fed along the Y-axis direction. As a result, indexing feed of the first machining unit 530A and the second machining unit 530B is carried out. Furthermore, the first Z-axis driving unit 522ZA and the second Z-axis driving unit 522ZB are driven to move the first Z-axis carriage 518ZA and the second Z-axis carriage 518ZB along the Z-axis direction, so that the first machining unit 530A and the second machining unit 530B are fed along the Z-axis direction. As a result, cutting feed of the first machining unit 530A and the second machining unit 530B is carried out. In addition, the table driving unit 526 is driven to rotate the work table 524 so as to switch the orientation (rotation position) of the wafer W. By combining the machining feed and rotation of the work table 524 and the indexing feed and cutting feed of the first machining unit 530A and the second machining unit 530B, the cut groove C is produced by machining the wafer W on the work table 524.

In the dicing device 500 with the above configuration, when the X-axis driving unit 522X is driven to move the work table 524 along the X-axis direction, imaging positions in the X-axis direction subjected to imaging by the first imaging unit 100 and the second imaging unit 200 is changed. When the first Y-axis driving unit 522YA and the second Y-axis driving unit 522YB are driven to move the first Y-axis carriage 518YA and the second Y-axis carriage 518YB along the Y-axis direction, the imaging positions in the Y-axis direction subjected to imaging by the first imaging unit 100 and the second imaging unit 200 are changed. In addition, the table driving unit 526 is driven to rotate the work table 524, so that the orientation (rotation position) of the wafer W is changed. Furthermore, when the first Z-axis driving unit 522ZA and the second Z-axis driving unit 522ZB are driven to move the first Z-axis carriage 518ZA and the second Z-axis carriage 518ZB along the Z-axis direction, the first imaging unit 100 and the second imaging unit 200 are made to perform scanning along the Z-axis direction.

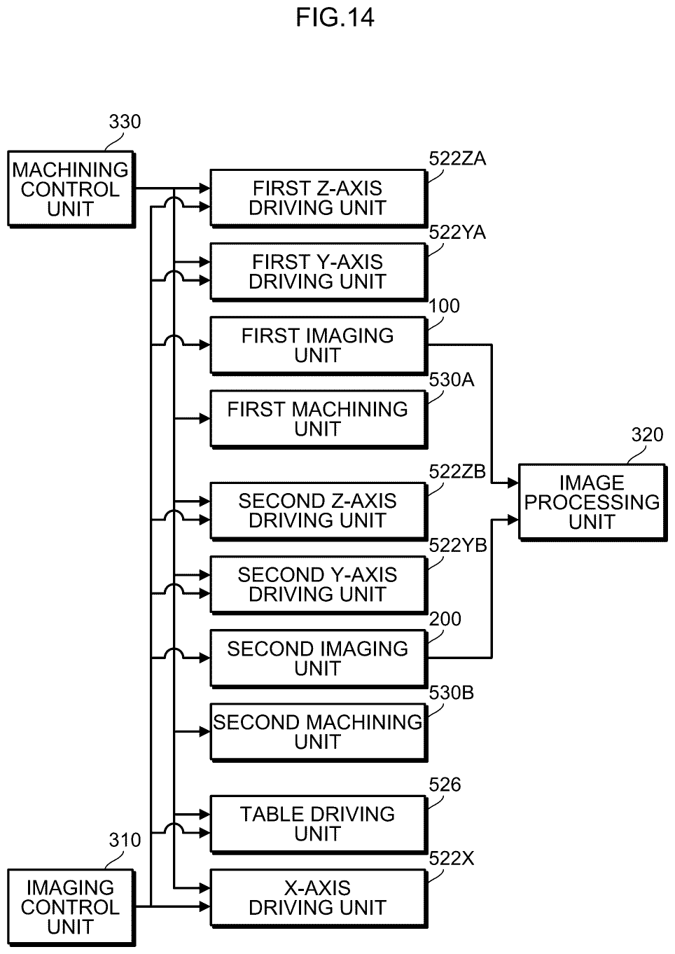

FIG. 14 is a block diagram of a control system of the machining part in the dicing device.

The dicing device 500 includes a machining control unit 330 which controls machining by the machining part 510, and an imaging control unit 310 which controls imaging by the first imaging unit 100 and the second imaging unit 200.

The machining control unit 330 controls the table driving unit 526, the X-axis driving unit 522X, the first Y-axis driving unit 522YA, the first Z-axis driving unit 522ZA, and the first machining unit 530A to control machining of the wafer W by the first machining unit 530A. The machining control unit 330 also controls the table driving unit 526, the X-axis driving unit 522X, the second Y-axis driving unit 522YB, the second Z-axis driving unit 522ZB, and the second machining unit 530B to control machining of the wafer W by the second machining unit 530B. The machining control unit 330 may be implemented by, for example, a computer including a processor and a memory. Hence, the computer executes a prescribed program to function as the machining control unit 330.

The imaging control unit 310 controls the table driving unit 526, the X-axis driving unit 522X, the first Y-axis driving unit 522YA, the first Z-axis driving unit 522ZA, and the first imaging unit 100 to control imaging of the wafer W by the first imaging unit 100. The imaging control unit 310 also controls the table driving unit 526, the X-axis driving unit 522X, the second Y-axis driving unit 522YB, the second Z-axis driving unit 522ZB, and the second machining unit 530B to control imaging of the wafer W by the second imaging unit 200.

The image processing unit 320 processes the images taken by the first imaging unit 100 and the second imaging unit 200 to measure the shape of the surface of the wafer W. The image processing unit 320 measures the shape of the machined cut groove C in particular.

[Operation]

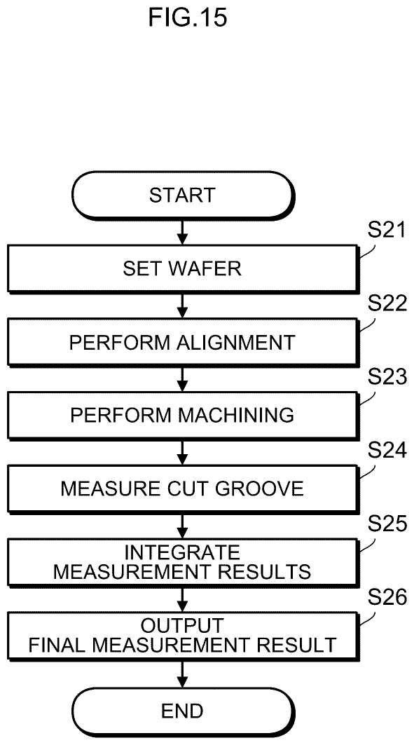

FIG. 15 is a flowchart illustrating a processing flow of machining and measurement of the wafer by the dicing device.

First, the wafer W as an object to be machined is set on the work table 524 (step S21).

Next, alignment of the wafer W is performed (step S22). The alignment is an operation to obtain the position of the street. The position of the street ST is obtained, for example, based on the alignment mark AM (see FIG. 6). The alignment mark AM is detected using the first imaging unit 100. Hence, the surface of the wafer W is imaged by the first imaging unit 100, and the alignment mark AM is detected from the image obtained by imaging. During the detection process, the height position (the position in the Z-axis direction) of the surface of the wafer W is detected. Accordingly, the position where the surface is in focus is detected, and the height position of the surface is detected based on the detection result.

Then, machining is performed (step S23). Specifically, the cut groove C is produced by machining along the street ST with the rotating blades 532A and 532B.

After machining, the shape of the cut groove C is measured (step S24). Measurement is performed using the second imaging unit 200. Accordingly, the three-dimensional shape of the cut groove C is measured using the second imaging unit 200. To be more specific, the second imaging unit 200 is made to scan in the Z-axis direction at the position of the cut groove C to take inference images, and the obtained images are processed to measure the three-dimensional shape of the cut groove C.

Here, the measured position is known from the result of alignment. Therefore, the second imaging unit 200 is moved to the measurement position using the alignment result. The height position of the surface of the wafer W is also known from the alignment result. Thus, the scanning range is set using the alignment result.

Next, when the measurement of the cut groove C with the second imaging unit 200 is finished, integration processing of the measurement results is carried out (step S25). Here, for the measurement result of the cut groove C (three-dimensional shape data on the cut groove C) by the second imaging unit 200, processing of specifying the surface position (the position in the Z-axis direction) is performed using the information on the height position of the surface obtained by the alignment.

The integrated measurement result is output to a display device included in the dicing device 500 as the measurement result of the final three-dimensional shape (step S26).

As described in the foregoing, the dicing device 500 in the present embodiment can measure the shape of the cut groove C after machining. At the time of measurement, the shape of the cut groove C can be measured efficiently and with high accuracy by using the information (information on the measurement position and the height position of the surface) obtained during alignment.

[Modifications]

The embodiments disclosed have been described by taking as an example the case where the presently disclosed subject matter is applied to the blade dicer. However, the presently disclosed subject matter is not limited to the example. The presently disclosed subject matter is also applicable to other machining devices. The dicing device is also applicable to devices which produce the cut groove C by machining with a laser.

The embodiments disclosed are configured such that the imaging part and the machining unit share the driving part. However, the imaging part and the machining unit may be driven independently. In addition, a measuring part may be provided separately from the machining part, and the measuring part may be configured to measure the wafer W after machining.

### REFERENCE SIGNS LIST

1 . . . measuring device, 10 . . . table, 12 . . . mounting surface, 20 . . . table driving unit, 100 . . . first imaging unit, 110 . . . first microscope unit, 11 . . . illumination part, 111A . . . illumination light source, 111B . . . illumination lens, 112 . . . beam splitter, 113 . . . objective lens, 113A . . . first objective lens, 113B . . . second objective lens, 114 . . . image forming lens, 115 . . . revolver, 120 . . . first camera unit, 121 . . . imaging element, 130 . . . first driving unit, 130X . . . first X-axis driving unit, 130Y . . . first Y-axis driving unit, 130Z . . . first Z-axis driving unit, 200 . . . second imaging unit, 210 . . . second microscope unit, 211 . . . illumination part, 211A . . . white light source, 211B . . . illumination lens, 212 . . . first beam splitter, 213 . . . objective lens, 214 . . . glass plate, 214A . . . reference mirror, 215 . . . second beam splitter, 216 . . . image forming lens, 220 . . . second camera unit, 221 . . . imaging element, 230 . . . second driving unit, 230X . . . second X-axis driving unit, 230Y . . . second Y-axis driving unit, 230Z . . . second Z-axis driving unit, 300 . . . computer, 310 . . . imaging control unit, 320 . . . image processing unit, 320A . . . focus position detection unit, 320B . . . surface position detection unit, 320C . . . measurement position detection unit, 320D . . . three-dimensional shape data generation unit, 320E . . . integration processing unit, 320F . . . edge detection unit, 320G . . . first three-dimensional shape data generation unit, 320H . . . second three-dimensional shape data generation unit, 330 . . . machining control unit, 500 . . . dicing device, 510 . . . machining part, 512 . . . base, 514 . . . saddle, 516 . . . portal column, 518X . . . X-axis carriage, 518YA . . . first Y-axis carriage, 518YB . . . second Y-axis carriage, 518ZA . . . first Z-axis carriage, 518ZB . . . second Z-axis carriage, 520X . . . X-axis guide rail, 520Y . . . Y-axis guide rail, 520ZA . . . first Z-axis guide rail, 520ZB . . . second Z-axis guide rail, 522X . . . X-axis driving unit, 522YA . . . first Y-axis driving unit, 522YB . . . second Y-axis driving unit, 522ZA . . . first Z-axis driving unit, 522ZB . . . second Z-axis driving unit, 524 . . . work table, 526 . . . table driving unit, 530A . . . first machining unit, 530B . . . second machining unit, 532A . . . blade, 532B . . . blade, 534A . . . spindle, 534B . . . spindle, 536A . . . spindle driving part, 536B . . . spindle driving part, AM . . . alignment mark, C . . . cut groove, F . . . dicing frame, IM1 . . . image, SA . . . measurement object area, ST . . . street, W . . . wafer

What is claimed is:

1. A measuring device, comprising:
a table having a mounting surface on which a workpiece is to be mounted, the mounting surface being parallel to a plane including an X-axis and a Y-axis, with respect to the X-axis, the Y-axis, and a Z-axis which are orthogonal to each other;
a first imaging unit configured to image a surface of the workpiece on the table;
a second imaging unit configured to image the surface of the workpiece on the table, the second imaging unit allowing measurement of a shape and/or roughness of the surface of the workpiece according to a plurality of images taken by scanning the surface of the workpiece in a Z-axis direction;
a driving part configured to move the first imaging unit and the second imaging unit relative to the table along directions of the X-axis, the Y-axis and the Z-axis;
an imaging control unit configured to control the first imaging unit, the second imaging unit, and the driving part so as to control imaging of the workpiece by the first imaging unit and the second imaging unit; and
an image processing unit configured to process the image of the surface of the workpiece taken by the first imaging unit and the plurality of images taken by scanning the surface of the workpiece in the Z-axis direction by the second imaging unit, so as to measure the shape and/or the roughness of the surface of the workpiece.

2. The measuring device according to claim 1, wherein
the image processing unit includes
a first image processing unit configured to process a plurality of images, taken by scanning the surface of the workpiece in the Z-axis direction by the first imaging unit, so as to detect a position and/or an edge of the surface of the workpiece in the Z-axis direction,
a second image processing unit configured to process the plurality of images, taken by scanning the surface of the workpiece in the Z-axis direction by the second imaging unit, so as to measure the position and/or the roughness of the surface of the workpiece, and
an integration processing unit configured to integrate processing results of the first image processing unit and the second image processing unit to calculate a final shape and/or roughness.

3. The measuring device according to claim 2, wherein the integration processing unit specifies the position and/or the edge of the surface of the workpiece in the Z-axis direction, based on at least a detection result of the position and/or the edge of the surface of the workpiece in the Z-axis direction by the first image processing unit.

4. The measuring device according to claim 2, wherein the imaging control unit sets a scanning range in the Z-axis direction by the second imaging unit, based on information on the position of the surface of the workpiece in the Z-axis direction which is detected by the first image processing unit.

5. The measuring device according to claim 1, wherein
the first imaging unit images the surface of the workpiece with a wider visual field than the second imaging unit, and
the image processing unit detects a measurement position based on the image taken by the first imaging unit.

6. The measuring device according to claim 1, wherein the first imaging unit has a function to switch an imaging magnification.

7. The measuring device according to claim 2, wherein the first image processing unit processes a plurality of images different in focal position, taken by scanning the surface of the workpiece in the Z-axis direction by the first imaging unit, so as to measure the shape and/or the roughness of the surface of the workpiece.

8. The measuring device according to claim 7, wherein the integration processing unit specifies the position and/or the edge of the surface of the workpiece in the Z-axis direction, based on at least a processing result by the first image processing unit.

9. The measuring device according to claim 8, wherein when the surface of the workpiece includes an area constituted of a smooth surface, the integration processing unit calculates a shape and/or roughness of the area constituted of the smooth surface, based on a processing result by the second image processing unit, and calculates a shape and/or roughness of areas other than the area constituted of the smooth surface, based on the processing result by the first image processing unit.

10. The measuring device according to claim 1, wherein the second imaging unit images the surface of the workpiece using an optical interference system or a confocal system.

11. The measuring device according to claim 1, wherein the driving part independently moves the second imaging unit and the first imaging unit with respect to the table at least in the direction of the Z-axis.

12. The measuring device according to claim 1, wherein the driving part independently moves the second imaging unit and the first imaging unit with respect to the table at least in the directions of the Z-axis and the Y-axis.

13. The measuring device according to claim 1, wherein the driving part further rotates the table.

14. A machining device, comprising:
the measuring device according to claim 1;
a machining part configured to machine the workpiece on the table; and
a machining control unit configured to control machining by the machining part.

15. The machining device according to claim 14, wherein the machining control unit performs alignment of the workpiece based on the image taken by the first imaging unit.
